(19) United States
(12) Patent Application Publication
(10) Pub. No.: US 2015/0260390 A1
(43) Pub. Date: Sep. 17, 2015

(54) Composite Heat Sink For Electrical Components

(71) Applicant: Eric Colin Bretschneider, Bowling Green, KY (US)

(72) Inventor: Eric Colin Bretschneider, Bowling Green, KY (US)

(21) Appl. No.: 14/210,442

(22) Filed: Mar. 14, 2014

(51) Int. Cl. F21V 29/76; F21V 19/00; F21V 23/00

(52) U.S. Cl. CPC F21V 29/76; F21V 23/002; F21V 19/0055; F21Y 2101/02

(57) ABSTRACT

A composite heat sink with improved mechanical strength and thermal conductivity can be made using a printed circuit board with machined recesses on the back side. The printed circuit board is mated to a heat sink with surface features that match the machined side of the printed circuit board. A thin layer of thermally conductive material such as a gap filler pad, thermal grease, thermal gel, thermal epoxy or the like may be added between the printed circuit board and the heat sink prior to joining them together. Mechanical attachments such as screws, rivets and snap features may be used to form the printed circuit board and the heat sink into a single composite structure.

The machined recesses in the printed circuit board are machined from the areas under and near surface mount components that generate a significant amount of heat. This reduces the thickness of printed circuit board material under the surface mount components and significantly improves thermal conduction.

### RELATED APPLICATION

This application claims the benefit of priority from U.S. Application No. 61/786,513 filed on Mar. 15, 2013, the contents of which are hereby incorporated by reference as if fully set forth herein.

### BACKGROUND OF THE INVENTION

Virtually all electrical devices contain printed circuit boards with one or more attached electrical components. All electrical components generate some heat that must be dissipated into the environment. This is typically accomplished by mounting the printed circuit board on a heat sink with a generally planar surface. Heat is transferred to the heat sink via conduction. Conduction further serves to spread the heat load throughout the body of the heat sink. At one or more external surfaces, heat is transferred to the environment via convection. Some minor amounts of heat may also be transferred to the environment via thermal radiation. However since heat transfer via radiation is proportional to the difference between the 4^{th} power of the absolute temperature between the heat sink and the environment (i.e. Q∝Tₕ⁴−Tₐ⁴ where Q is the heat flow, Tₕ is the absolute temperature of the heat sink and Tₐ is the absolute temperature of the environment). For low levels of heat generation, the printed circuit boards may be composed of a fiber glass based material such as FR4. These circuit boards may contain so called thermal vias to help transfer heat to the back side of the board. Thermal vias are small holes in the printed circuit board that are plated with a metallic material. This allows for much higher rates of heat conduction between the front side and back side surfaces of the printed circuit board. Heat conduction is still limited because of the low cross sectional area of metal in the thermal vias.

The ability of material to transfer heat can be characterized by the thermal resistance. This is the product of the thermal conductivity of the material (W/m° K) and the thickness of the material. Thermal resistance thus has units of W/° K (or equivalents). FR4 materials have a thermal conductivity of about 0.29 W/m° K. Typical aluminum alloys have a thermal conductivity of 160-240 W/m° K. Thus for a given thickness of material, aluminum is able to conduct heat 600-900 times better than FR4 materials.

From here simple arguments lead to the use of metal core printed circuit boards for higher heat loads. These boards are composed of a high thermal conductivity metal (typically an aluminum alloy). A thin layer of a dielectric material is then applied to one side of the core board. Tradition electrically conductive traces are then patterned on top of the dielectric layer in a standard processes. This allows for a rigid printed circuit board with excellent thermal conduction capabilities.

Unfortunately the better thermal performance of metal core printed circuit boards comes at a significant price premium. The thermal conductivity of air is about 0.026 W/m° K, thus even a thin layer of air between the dielectric film and the metal surface will significantly increase the thermal resistance of the metal core printed circuit board. This requires the metal to have a very flat and smooth surface which in turn requires a precise machining and bonding process to eliminate any air pockets between the dielectric and the metal surface.

The processing conditions for dielectric materials and electrical traces also limits the range of metal allows that may be used for the metal core. This limits efforts at price reduction. Certain aluminum alloys and copper based materials are commonly used for metal core boards. Other metals and alloys are not used due to their incompatibility with the printed circuit forming process.

There is a limit to the thickness of metal that can be used in metal core printed circuit boards. This limit is imposed by the processing steps used to form metal core printed circuit boards. The limit of this process is about 0.200 inches. While this is thick enough to act as a structural component, the side of the circuit board opposite the electrical components is smooth. This limits the ability of this surface to act as an effective heat transfer component. The rate of heat transfer from a surface via convection is dependent on the area of the surface. A flat surface has a minimum area. Texturing the surface to form ridges, fins or pins would greatly increase the surface area and substantially improve heat transfer via convection. However the lamination process for applying the dielectric to the metal surface requires smooth planar surfaces on both sides of the metal.

The smooth backside surface of metal core boards means that they are almost always mounted onto heat sinks. This contradictory situation is forced upon users by the processing steps required to form a metal core printed circuit board.

While the cost of thermal vias to a standard FR4 type printed circuit board is much less than a metal core printed circuit board, the heat transfer performance is still much lower than metal core printed circuit boards. Thin FR4 type printed circuit boards may be used to reduce the overall thermal resistance, but these boards may be flexible. This flexibility may severely comprise the ability to mount the printed circuit board to a heat sink without introducing detrimental air pockets and voids.

Recently so called selective area heat sinks have been developed as outlined in U.S. Pat. No. 7,910,943 the contents of which are included herein by reference. These utilize heat sinks with protrusions that align to high temperature regions on the back of a planar printed circuit board. The printed circuit board is maintained at its nominal thickness and thermal vias are relied on to increase thermal conductivity through the printed circuit board.

These selective area heat sink devices use screws and other similar attachment methods are used to secure the printed circuit board to the heat sink protrusions. The completed assembly constrains the location of the protrusions to a region between the printed circuit board and a generally planar surface from which the protrusions extend. If such a device is mounted so that the LED side of the printed circuit board is oriented in a vertical direction, the effectiveness of convective heat transfer is severely reduced. It is also difficult in such devices to secure optics as a mechanical attachments must extend through the printed circuit board to the surface from which the protrusions extend. Additional features and components may be used to secure optics, but these add cost and complexity. Printed circuit boards lack the mechanical strength to allow simple installation of optical components which can form a seal around the LEDs and isolate them from the environment.

### BRIEF SUMMARY OF THE INVENTION

The present invention comprises a printed circuit board comprised of an electrically insulating material with a first major surface and a second major surface. The first major surface includes at least one set of solder pads configured for a heat generating surface mount electrical component. The second major surface is machined to reduce the thickness in an area proximal to the solder pads for the heat generating electrical component. A heat sink comprised of a thermally conductive materials includes a nominally planar surface which includes features that match the machined recesses in the printed circuit board. I thermally conductive material is disposed in the recessed areas of the printed circuit board and the printed circuit board and heat sink are joined together.

The printed circuit board and the heat sink include additional features that allow a strong mechanical connection to be made between them. This mechanical connection may be made using screws, clips, rivets and other means known in the art. If the heat generating surface mount components are light emitting diodes (LEDs), the heat sink and printed circuit board may also include additional features that allow an optic to be mounted over in a manner which allows the LEDs to be isolated from the ambient environment.

In one preferred embodiment the heat generating surface mount components are disposed in a linear manner. In this embodiment the machined recess on the side of the printed circuit board opposite the heat generating surface mount components is also a linear feature. In this embodiment the heat sink may be an extruded component. In this embodiment the heat generating components may be disposed in multiple lines so long as the lines are parallel to each other.

In another preferred embodiment the machined recesses on the side of the printed circuit board opposite the heat generating surface mount components are not formed as parallel linear features. In this embodiment the heat sink is formed from a casting process, injection molding process or a machining process. Combinations of these processes may also be used.

In some embodiments the heat generating surface mount components are light emitting diodes (LEDs). In some embodiments an optic is mounted over the LEDs utilizing features in the printed circuit board and the heat sink to form an optical module. The optical modules may further include a polymeric material between the printed circuit board and the optic to provide an environmental seal between the LEDs and the ambient environment.

### BRIEF DESCRIPTION OF THE DRAWINGS

FIGS. 1A and 1B illustrate an exploded view of a prior art printed circuit board and heat sink.

FIG. 2 illustrates an embodiment of a composite heat sink of the present invention.

FIGS. 3A and 3B illustrate another embodiment of a composite heat sink of the present invention.

### DETAILED DESCRIPTION OF THE INVENTION

Printed circuit boards are commonly made using rigid composite materials such as FR4 or CEM. These materials have excellent electrical insulating and dielectric properties. They are also physically strong and rigid and have excellent flame resistance. The term FR4 derives from Flame Retardant type 4. They are also inexpensive.

This host of attractive features and properties is balanced against a significant weakness-low thermal conductivity. FR4 has a through plane thermal conductivity of about 0.29 W/m° K. This stands in stark contrast to aluminum alloys commonly used to produce aluminum core printed circuit boards. These aluminum alloys have thermal conductivities that range from about 100 W/m° K to about 180 W/m° K. This makes these materials about 300 to about 600 times better thermal conductors.

The units of thermal conductivity are W/m° K. Knowing this, the thermal resistance across a given thickness of material can be calculated by multiplying the thermal conductivity of the material by the material thickness. This gives the thermal resistance in units of W/° K.

This illustrates the weakness of FR4 printed circuit boards when they are used with high power electrical devices that generate significant amounts of heat when they are operated. It is difficult to dissipate any heat generated by conduction through the FR4 material.

So called thermal vias are a common method to improve thermal conductivity through the thickness of an FR4 printed circuit board. Thermal vias are small holes that extend through the entire thickness of a printed circuit board. The sidewalls of these holes are coated with a metal (typically copper) that is contiguous with layers of metal on opposite sides of the printed circuit board.

These vias offer a low cost approach to improving thermal conductivity, but thin layer of metal limits their effectiveness. The limitations are imposed by another feature of thermal conductivity, namely thermal flux. Thermal flux is a measure of the amount of heat transferred per unit area. Although the heat flux through the metal coatings on the walls of the thermal via, the total heat transferred is low since the cross sectional area of the thermal vias is low.

A complication of thermal vias is the fact that they are composed of metal which has a very high electrical conductivity. Safety requirements may require significant spacing between energized electrical components and metal components that humans may come into contact with. These types of restrictions limit how close thermal vias may be placed to an electrical component or require an electrically insulating material between the bottom side of the thermal via and the heat sink.

A prior method to improve thermal conductivity through a printed circuit board with surface mount electrical components is use of a so-called metal core board. Metal core boards use a sheet of metal with a thin layer of electrically insulating material disposed on one surface. Electrical traces and solder pads are then formed on the surface of the thin layer of electrically insulating material in a manner similar to that used for printed circuit boards comprising FR4.

The process steps used in production of metal core boards places a strict tolerance on the flatness of the metal layer used to form the core. There is also a limit on how thick the metal core can be. At the present time this limit is about 0.200 inches.

The requirements for flatness and smoothness impose a significant cost penalty by themselves. The cost of the metal material as well is significantly higher than for FR4 type materials. This makes use of metal core boards economically unfavorable from the perspective of printed circuit board production.

Additionally the limits on overall thickness of the metal core layer result in printed circuit boards that must still be mounted onto a heat sink. The interface between the metal core printed circuit board and the heat sink is a potential area to increase overall thermal resistance. To combat this, a thermal interface material such as thermal grease, thermal epoxy, thermal gel or gap pad may be disposed between the metal core printed circuit board and the heat sink.

Thus designers are left with using an FR4 type printed circuit board with poor overall thermal performance, but low cost or a metal core printed circuit board with better thermal performance, but high overall cost. In both cases a heat sink is required as well as some type of thermal interface material. Further, both cases are generally limited to planar mating surfaces.

The present invention provides an means to overcome these issues.

In one embodiment surface mount electrical components are soldered or otherwise attached to one side of an electrically insulating printed circuit board. Either before or after mounting the electrical components a series of recessed features are machined in the printed circuit board proximal to mounting locations of the surface mount components.

These recessed features reduce the thickness of FR4 or similar material with a low thermal conductivity by about 50% to about 90% or even as much at 95%. Since thermal resistivity is the product of thermal conductivity and thickness this allows thermal resistance to be improved by about a factor of 2 to about a factor of 20.

A heat sink is also provided with protruding features that correspond to the recessed features of the printed circuit board. The heat sink component may be produced by a casting, forging, extruding, machining process or a combination of any of these processes.

The printed circuit board with recessed features and the heat sink component with protruding features are mounted together to form a composite structure. A thermal interface material such as thermal grease, thermal epoxy, thermal gel or gap pad may be disposed between the printed circuit board and the heat sink component to further improve thermal conductivity. A variety of mounting methods may be used to form the composite structure. Non-limiting examples include screws, bolts, rivets, clips, snaps and press fit features.

This results in a composite heat sink structure with superior thermal transfer properties. The low cost and high electrical resistivity benefits of standard FR4 type printed circuit boards are maintained and combined with the superior thermal transfer capabilities of metal core board printed circuit boards.

By machining away only the portions of the printed circuit board material proximal to the mounting locations of the surface mount electrical components requiring heat dissipation the majority of the printed circuit board material may be kept and so preserve the strength of the printed circuit board assembly

In this manner a composite heat sink comprising a printed circuit board with surface mount electrical components.

In one embodiment of the present invention the recessed features in the printed circuit board may be linear recessed features. This increases the flexibility of the printed circuit board in the direction perpendicular to the linear recessed features. This in turn allows the printed circuit board to be flexed and installed on a curved surface.

In another embodiment one or more recessed features may be present that do not correspond locations of surface mount components. These features may be machined in the printed circuit board to allow for flexibility and have no significant thermal management role.

This capability to form controlled curved surfaces presents a new capability. Notably this may be advantageous for printed circuit boards that include light emitting diodes (LEDs). This ability may be particularly beneficial when the curvature is used to control and modify the light distribution pattern from the LEDs on the printed circuit board.

In some embodiments an optical component is mounted to the surface of the printed circuit board in relation to at least one LED. Advantageously the optical component may be mounted using the same mounting hardware used to join the printed circuit board and the heat sink element. This results in the formation of a composite structure with optical control capabilities in addition to superior thermal transfer capabilities.

### DETAILED DESCRIPTION OF THE DRAWINGS

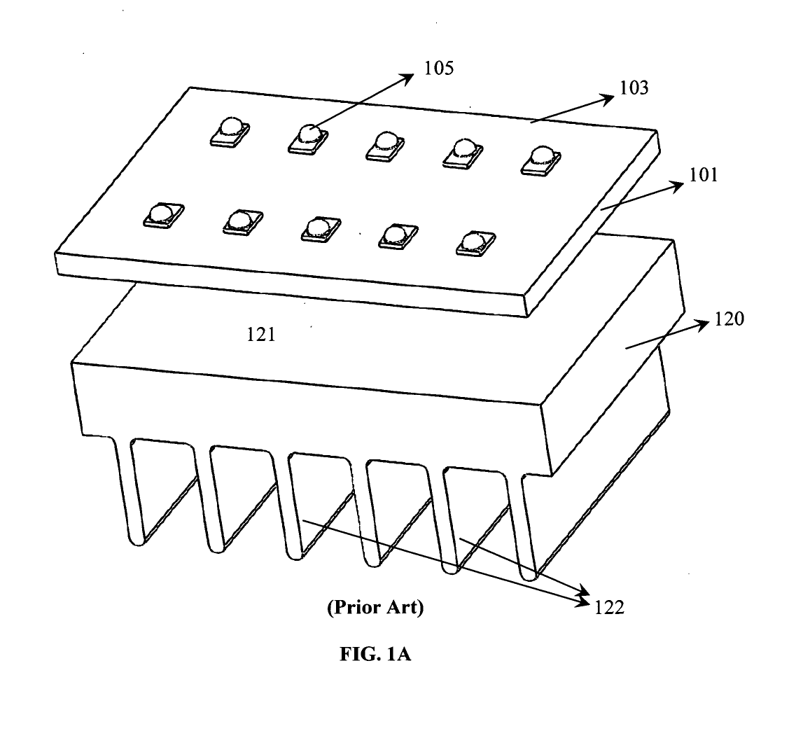

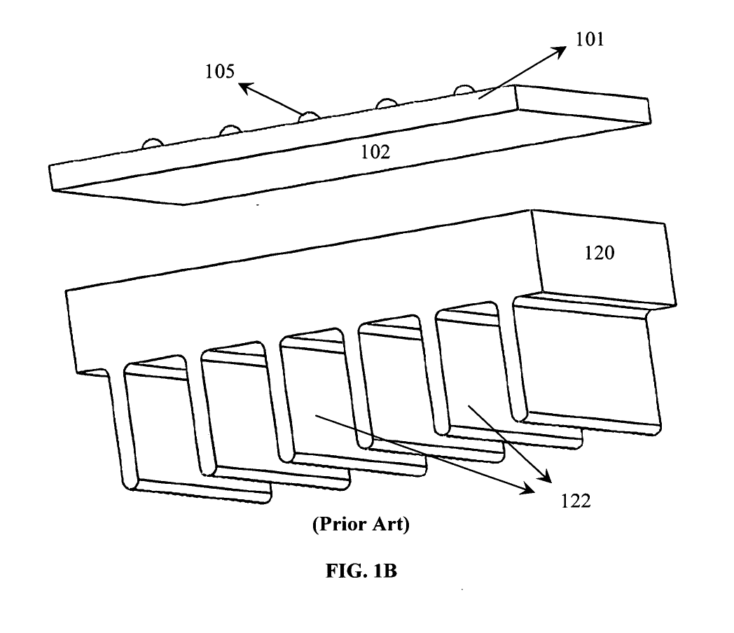

FIGS. 1A and 1B illustrate a typical heat sink 120 used in conjunction with a printed circuit board 101. The printed circuit board 101 has surface mount electrical components 105 soldered or otherwise connected to a mounting surface 103. The back surface 102 of the printed circuit board 101 is featureless and forms a planar surface.

The heat sink 120 has a planar mounting surface 121 that is intended to match to the back surface 102 of the printed circuit board 101. A thermal interface material (not shown) is typically disposed between the back surface 102 of the printed circuit board 101 and the mounting surface 121 of the heat sink 120 to improve conductive heat transfer from the printed circuit board 101 and the heat sink 120.

Fins 122 or other heat dissipating structures are commonly present as features of the heat sink 120. Heat transfer from the heat dissipation structures 122 occurs by convection. Increasing the surface area improves heat transfer to the ambient environment.

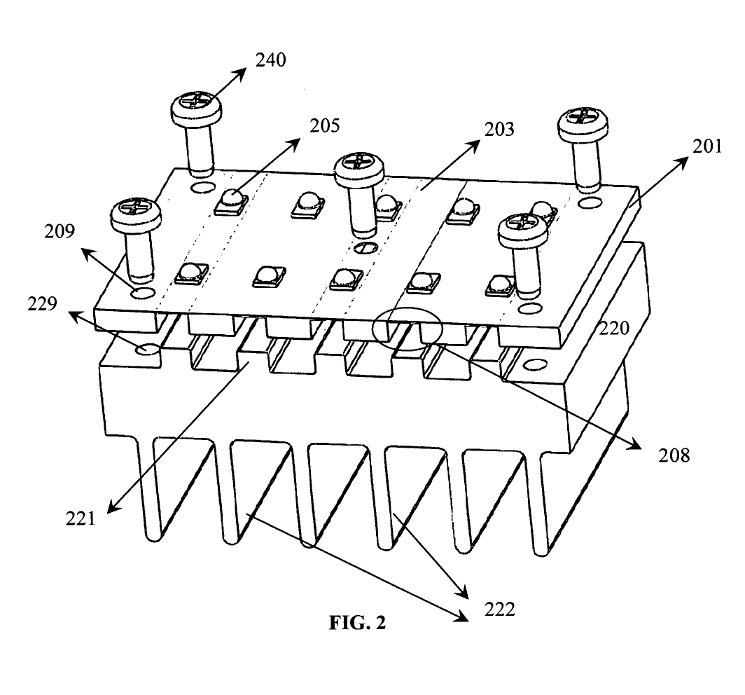

FIG. 2 illustrates one embodiment of the present invention. In this embodiment a printed circuit board 201 has surface mount electrical components 205 soldered or otherwise attached on a mounting surface 203. The back surface (not shown) of the printed circuit board 201 is nominally planar, but includes a series of linear recessed features 208 that align with the surface mount electrical components 205 on the mounting surface 203 of the printed circuit board 201. The heat sink 220 includes a series of protruding features 221 that correspond to the recessed features 208 of the printed circuit board 201. In this manner the distance for heat conduction through the material of the printed circuit board 201 may be dramatically reduced.

The printed circuit board 201 also includes mounting features 209 that align with another series of heat sink mounting features 229 so that the printed circuit board 201 can be physically mounted to the heat sink 220. Screws 240 or other mounting hardware components may be used to maintain close physical contact between the printed circuit board 201 and the heat sink 220. As with prior art heat sinks, a thermal interface material (not shown) may be disposed between the printed circuit board 201 and the heat sink 220.

The depth of the recessed features 208 may be about 50% to about 95% of the total printed circuit board 201 thickness.

In some embodiments the surface mount electrical components 205 may include light emitting diodes (LEDs). In these embodiments the screws 240 or other mounting hardware components may further serve to mount an optical element (not shown) in a desired relation to the LEDs. In this manner the recessed features 208 of the printed circuit board 201 act with the protruding features 221 of the heat sink 220 to form a composite structure with efficient thermal conduction properties.

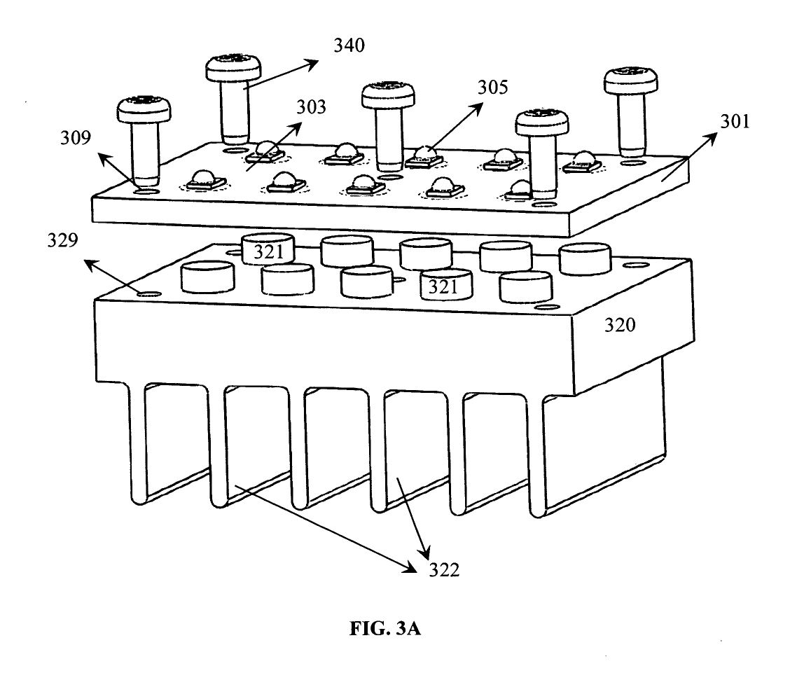

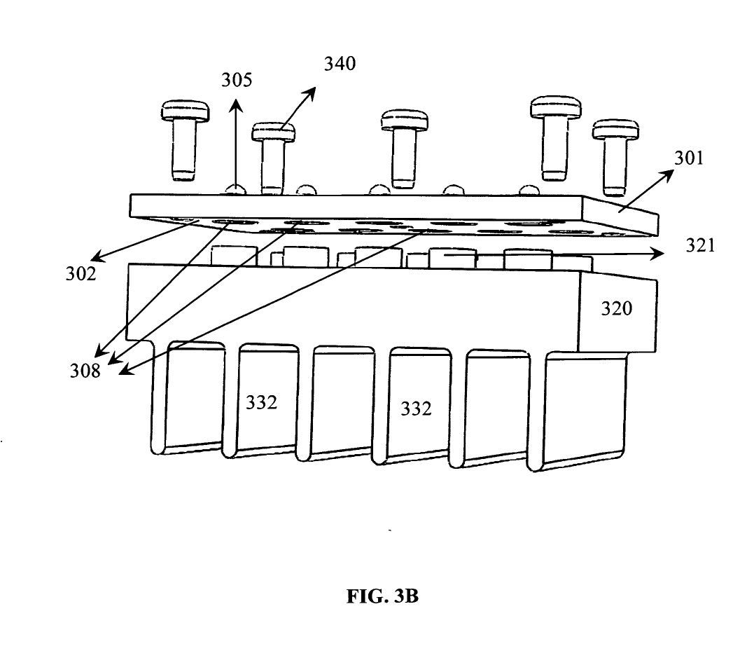

FIGS. 3A and 3B illustrate another embodiment of the present invention. In this embodiment a printed circuit board 301 has surface mount electrical components 305 soldered or otherwise attached on a mounting surface 233. The back surface 302 of the printed circuit board 301 is nominally planar, but includes a series of isolated recessed features 308 that align with the surface mount electrical components 305 on the mounting surface 303 of the printed circuit board 301. The heat sink 320 includes a series of protruding features 321 that correspond to the recessed features 308 of the printed circuit board 301. In this manner the distance for heat conduction through the material of the printed circuit board 301 may be dramatically reduced.

The printed circuit board 301 also includes mounting features 309 that align with another series of heat sink mounting features 329 so that the printed circuit board 301 can be physically mounted to the heat sink 320. Screws 340 or other mounting hardware components may be used to maintain close physical contact between the printed circuit board 301 and the heat sink 220. As with prior art heat sinks, a thermal interface material (not shown) may be disposed between the printed circuit board 301 and the heat sink 320.

The depth of the recessed features 308 may be about 50% to about 95% of the total printed circuit board 301 thickness.

In some embodiments the surface mount electrical components 305 may include light emitting diodes (LEDs). In these embodiments the screws 340 or other mounting hardware components may further serve to mount an optical element (not shown) in a desired relation to the LEDs. In this manner the recessed features 308 of the printed circuit board 301 act with the protruding features 321 of the heat sink 320 to form a composite structure with efficient thermal conduction properties.

While the invention has been described in detail in connection with only a limited number of embodiments, it should be readily understood that the invention is not limited to such disclosed embodiments. Rather, the invention can be modified to incorporate any number of variation, alterations, substitutions or equivalent arrangements not heretofore described, but which are commensurate with the spirit and scope of the invention. Additionally, while various embodiments of the have been described, it is to be understood that aspects of the invention may include only some of the described embodiments. Accordingly, the invention is not to be seen as limits by the foregoing description, but is only limited by the scope of the appended claims.

What is claimed:

1. A composite heat sink for surface mount electrical components that generate heat during operation comprising
a printed circuit board comprising an electrically insulating material with a first major surface and a second major surface
at least one surface mount electrical component mounted on said first major surface that generates heat during operation
at least one series of electrical traces on said first major surface comprising an electrical circuit that includes at least one said surface mount electrical component that generates heat during operation
at least one recess on said second major surface disposed proximal to said surface mount electrical component that generates heat during operating wherein the depth of said recess is at least 30% of the thickness of said printed circuit board
a heat sink comprised of a thermally conductive material with at least one major surface wherein said major surface has at least one protrusion that aligns with said recess on said second major surface of said printed circuit board
wherein said printed circuit board and said heat sink include features that allow for a mechanical attachment to be formed between said printed circuit board and said heat sink

2. A composite heat sink according to claim 1 wherein said recessed feature is a curvilinear feature

3. A composite heat sink according to claim 1 wherein said surface mount electrical component that generates heat during operation is a light emitting diode

4. A composite heat sink according to claim 1 wherein said major surface with protrusions of said heat sink is a planar surface

5. A composite heat sink according to claim 1 wherein said major surface with protrusions of said heat sink is a curved surface

6. A composite heat sink according to claim 1 wherein said major surface with protrusions of said heat sink is a concave surface or a convex surface

7. A composite heat sink according to claim 1 wherein said major surface with protrusions of said heat sink has at least one concave region and at least one convex region

8. A composite heat sink for surface mount electrical components that generate heat during operation comprising
a printed circuit board comprising an electrically insulating material with a first major surface and a second major surface
at least one surface mount electrical component mounted on said first major surface that generates heat during operation wherein said surface mount electrical component that generates heat during operating is a light emitting diode
at least one series of electrical traces on said first major surface comprising an electrical circuit that includes at least one said surface mount electrical component that generates heat during operation
at least one recess on said second major surface disposed proximal to said surface mount electrical component that generates heat during operating wherein the depth of said recess is at least 30% of the thickness of said printed circuit board
a heat sink comprised of a thermally conductive material with at least one major surface wherein said major surface has at least one protrusion that aligns with said recess on said second major surface of said printed circuit board
an optic disposed over said light emitting diode
wherein said printed circuit board and said heat sink and said optic include features that allow for a mechanical attachment to be formed between said optic said printed circuit board and said heat sink

9. A composite heat sink according to claim 6 wherein said recessed feature is a curvilinear feature

10. A composite heat sink according to claim 6 wherein said surface mount electrical component that generates heat during operation is a light emitting diode

11. A composite heat sink according to claim 6 wherein said major surface with protrusions of said heat sink is a planar surface

10. A composite heat sink according to claim 6 wherein said major surface with protrusions of said heat sink is a curved surface

11. A composite heat sink according to claim 1 wherein said major surface with protrusions of said heat sink is a concave surface or a convex surface

12. A composite heat sink according to claim 1 wherein said major surface with protrusions of said heat sink has at least one concave region and at least one convex region
